(19) United States
(12) Patent Application Publication
(10) Pub. No.: US 2023/0416595 A1
(43) Pub. Date: Dec. 28, 2023

(54) WELLBORE CLEANING COMPOSITIONS AND METHODS OF MAKING AND USING SAME

(71) Applicant: Halliburton Energy Services, Inc., Houston, TX (US)

(72) Inventors: Emily HART, Houston, TX (US); Hui ZHOU, Houston, TX (US); Jay DEVILLE, Houston, TX (US); William W. SHUMWAY, Houston, TX (US)

(21) Appl. No.: 18/103,140

(22) Filed: Jan. 30, 2023

Related U.S. Application Data
(60) Provisional application No. 63/356,348, filed on Jun. 28, 2022.

(51) Int. Cl. C09K 8/528

(52) U.S. Cl. CPC C09K 8/528

(57) ABSTRACT

A wellbore cleaning composition comprising (i) a surfactant consisting essentially of a sorbitan ester or a derivative thereof and, (ii) a base fluid. A wellbore treatment fluid comprising (1) (i) a surfactant consisting essentially of a sorbitan ester or a derivative thereof and, (ii) a base fluid and (2) an additional bulk fluid. A method of serving a wellbore disposed within a subterranean formation comprising circulating an oil-based drilling mud through an interior of a drill string and an annulus; and placing within the wellbore a wash pill comprising (1) a wellbore cleaning composition comprising (i) a surfactant consisting essentially of a polyethoxylated sorbitan ester or a derivative thereof and (ii) a base fluid and (2) a brine under conditions suitable for the conversion of one or more surfaces of the wellbore from oil-wet to water-wet.

### CROSS REFERENCE TO RELATED APPLICATIONS

This application claims priority to U.S. Provisional Application No. 63/356,348 filed Jun. 28, 2022, entitled “Wellbore Cleaning Compositions and Methods of Making and Using Same,” which is incorporated by reference herein in its entirety.

### FIELD

This application relates to a wellbore servicing fluid. More specifically, this application relates to a composition for use in cleaning surfaces encountered in a wellbore formation.

### BACKGROUND

Hydrocarbons, such as oil and gas, residing in a subterranean formation or zone are usually recovered by drilling a wellbore down to the subterranean formation while circulating a drilling fluid in the wellbore. The drilling fluid is usually circulated downward through the interior of the drill pipe and upward through the annulus, which is located between the exterior of the drill pipe and the interior wall of the wellbore. For example, drilling fluids or muds are commonly circulated in the well during such drilling to cool and lubricate the drilling apparatus, lift cuttings out of the wellbore, and counterbalance the subterranean formation pressure encountered.

Drilling fluids can be oil-based muds (OBM), synthetic oil-based muds (SBM) and/or water-based muds (WBM), which when circulated during the wellbore drilling process leaves the wellbore surface and other surfaces contaminated with components of the drilling fluid. Effective drilling mud removal, also referred to as mud cake or filter cake removal, facilitates both cementing success and completion operations. For example, before cementing, the casing and formation need to be water-wet so that cement can bond with both casing and formation. Thus, prior to completion of a well, the mud is displaced and the casing, tubular, and formation face are converted from an oil-wet state to a water-wet state (e.g., cleaned).

Conventional cleaning methods use a mixture of fresh water or seawater and cleaning agents to displace the mud and water-wet the surfaces. It would be desirable both financially and environmentally to reduce the number of cleaning agents used in these formulations while achieving effective removal of residual drilling mud.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIGS. 1A and 1B depict structures of polyethoxylated sorbitan esters.

FIG. 1C depicts the structure of an ethoxylated Guerbet alcohol.

FIG. 2 is a depiction of a wellbore operational environment.

FIG. 3 depicts a displacement train for servicing a wellbore.

FIG. 4 is a bar graph of the percent mud removal in 11.6 ppg CaCl₂ brine for the samples of Example 1 at a temperature of 40° F. (4.4° C.).

FIG. 5 is a bar graph of the percent mud removal in 12.5 ppg NaBr brine for the samples of Example 1 at a temperature of 40° F. (37.8° C.).

FIG. 6 is a bar graph of the percent mud removal in 14.2 ppg CaBr₂brine for the samples of Example 1 at a temperature of 40° F. (4.4° C.).

FIG. 7 is a bar graph of the percent mud removal in 14.2 ppg CaBr₂brine for the samples of Example 2 at a temperature of 100° F. (37.8° C.).

### SUMMARY

Disclosed herein is a wellbore cleaning composition comprising (i) a surfactant consisting essentially of a sorbitan ester or a derivative thereof and, (ii) a base fluid.

Also disclosed herein is a wellbore treatment fluid comprising (1) (i) a surfactant consisting essentially of a sorbitan ester or a derivative thereof and, (ii) a base fluid and (2) an additional bulk fluid.

Also disclosed herein is a method of serving a wellbore disposed within a subterranean formation comprising circulating an oil-based drilling mud through an interior of a drill string and an annulus; and placing within the wellbore a wash pill comprising (1) a wellbore cleaning composition comprising (i) a surfactant consisting essentially of a polyethoxylated sorbitan ester or a derivative thereof and (ii) a base fluid and (2) a brine under conditions suitable for the conversion of one or more surfaces of the wellbore from oil-wet to water-wet.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It is to be understood that “subterranean formation” encompasses both areas below exposed earth and areas below earth covered by water such as ocean or fresh water. Herein in the disclosure, “top” means the well at the surface (e.g., at the wellhead which may be located on dry land or below water, e.g., a subsea wellhead), and the direction along a wellbore towards the well surface is referred to as “up”; “bottom” means the end of the wellbore away from the surface, and the direction along a wellbore away from the wellbore surface is referred to as “down.” For example, in a horizontal wellbore, two locations may be at the same level (i.e., depth within a subterranean formation), the location closer to the well surface (by comparing the lengths along the wellbore from the wellbore surface to the locations) is referred to as “above” the other location, the location farther away from the well surface (by comparing the lengths along the wellbore from the wellbore surface to the locations) is referred to as “below” or “lower than” the other location.

Disclosed herein are wellbore cleaning compositions (e.g., cleaning agents) including a surfactant. In one or more embodiments, the wellbore cleaning composition includes a sorbitan ester (e.g., a polyethoxylated sorbitan ester) as a surfactant. In one or more embodiments, the wellbore cleaning composition includes a surfactant consisting essentially of a sorbitan ester (e.g., a polyethoxylated sorbitan ester). In one or more embodiments, the wellbore cleaning composition includes a single surfactant comprising a sorbitan ester (e.g., a polyethoxylated sorbitan ester).

In one or more embodiments, the wellbore cleaning composition includes an alkoxylated branched alcohol as a surfactant. In one or more embodiments, the wellbore cleaning composition includes a surfactant consisting essentially of an alkoxylated branched alcohol. The wellbore cleaning composition may further include a base fluid (e.g., an aqueous fluid). Hereinafter, a composition including a base fluid and a surfactant of the type disclosed herein for use in wellbore servicing is termed a wellbore cleaning composition (WCC).

In one or more embodiments, the WCC is introduced to a subterranean formation or casing disposed within a subterranean formation subsequent to a drilling fluid having been circulated therein. In one or more embodiments, the WCC may be combined with other components or additives to formulate a suitable wellbore treatment fluid comprising a WCC of the type disclosed herein. For example, the WCC may be combined with an additional type and/or quantity of aqueous fluid, e.g., brine, to form a wellbore treatment fluid that is also referred to as a wash pill. For example, a WCC of the type disclosed herein can be further combined (e.g., diluted) with a bulk aqueous fluid (e.g., brine) to form a wash pill, and the wash pill can be placed downhole and contacted with an oil-containing surface downhole to remove all or a portion of the oil from the contacted surface and/or convert the surface from oil-wet to water-wet.

In one or more embodiments, a WCC herein or a wellbore treatment fluid comprising the WCC (e.g., a wash pill comprising a WCC of the type disclosed herein and additional aqueous fluid such as brine) includes a second material that can function as a surfactant (e.g., a second surfactant compound) in an amount less than about 5 volume percent (vol. %), alternatively less than about 4 vol. %, alternatively less than about 3 vol. %, alternatively less than about 2 vol. %, alternatively less than about 1 vol. %, alternatively less than about 0.5 vol. %, alternatively less than about 0.25%, or alternatively an amount in a range of from about 0.1 vol. % to about 1, 2, 3, 4, or 5 vol. %. The volume percent is based on the total volume of the WCC disclosed herein or a wellbore treatment fluid comprising the WCC (e.g., a wash pill comprising a WCC of the type disclosed herein and additional aqueous fluid such as brine). The second material that can function as a surfactant may be another nonionic surfactant of the types disclosed herein or any other surfactant that does not interfere with the performance of the WCC.

In one or more embodiments, a surfactant for use in the WCC includes sorbitan esters, and/or derivatives thereof, including, but not limited to, sorbitan monolaurate, sorbitan monopalmitate, sorbitan monostearate, sorbitan monooleate, sorbitan sesquioleate, sorbitan trioleate, sorbitan isostearate, or polyethoxylated sorbitan esters. In one or more embodiments, the WCC includes from about 0.5 weight percent (wt. %) to about 40 wt. % of a sorbitan ester, or a derivative thereof; or from about 0.5 wt. % to about 30 wt. % of a sorbitan ester, or a derivative thereof; or from about 0.5 wt. % to about 20 wt. % of a sorbitan ester, or a derivative thereof; or from about 1 wt. % to about 25 wt. % of a sorbitan ester, or a derivative thereof; or from about 1 wt. % to about 15 wt. % of a sorbitan ester, or a derivative thereof; or from about 1 wt. % to about 30 wt. % of a sorbitan ester, or a derivative thereof; or from about 1 wt. % to about 35 wt. % of a sorbitan ester, or a derivative thereof; or from about 20 wt. % to about 30 wt. % of a sorbitan ester, or a derivative thereof. In one or more embodiments, the WCC may include about 0.5, 0.8, 1.0, 1.2, 1.4, 1.6, 1.8, 2.0, 2.2, 2.4, 2.6, 2.8, 3.0, 3.2, 3.4, 3.6, 3.8, 4, 5, 6, 7, 8, 9, 10, 12, 14, 16, 18, 20, 22, 24, 26, 28, 30, 32, 34, 36, 38, or 40 weight percent of a sorbitan ester, or a derivative thereof. Herein wt. % is based on the total weight of the composition being described unless indicated otherwise (e.g., based on the total weight of the WCC).

In one or more embodiments, the WCC includes a surfactant consisting or consisting essentially of a single sorbitan ester or a single sorbitan ester derivative. In one or more embodiments, the WCC includes a sorbitan ester having a molecular weight of less than about 2600 Daltons (Da), alternatively equal to about 2000 Da, alternatively equal to about 1500 Da, alternatively equal to about 1250 Da, alternatively equal to about 1000 Da, alternatively equal to about 750 Da, alternatively in a range of from about 500 Da to about 2600 Da, alternatively in a range of from about 500 Da to about 1450 Da, alternatively in a range of from about 700 Da to about 1200 Da, or alternatively in a range of from about 800 Da to about 1100 Da.

In one or more embodiments, a non-ionic surfactant suitable for use in the present disclosure consists or consists essentially of a sorbitan polyoxyethylene fatty acid ester. Nonlimiting examples of sorbitan polyoxyethylene fatty acid esters suitable for use in the present disclosure include but are not limited to polyethylene glycol sorbitan monolaurate, polyethylene glycol sorbitan monopalmitate, polyethylene glycol sorbitan monostearate, polyethylene glycol sorbitan tristearate, and polyethylene glycol sorbitan monooleate. In one or more embodiments, the non-ionic surfactant is a sorbitan ester that is a polyethoxylated sorbitan monolaurate, or a polyethoxylated sorbitan monooleate.

In one or more embodiments, the non-ionic surfactant is a polyethoxylated sorbitan ester including from about 4 to about 40 moles of ethylene oxide, alternatively from about 10 to about 30 moles of ethylene oxide, alternatively from about 10 to about 25 moles of ethylene oxide, alternatively from about 4 to about 20 moles of ethylene oxide, alternatively from about 10 to about 20 moles of ethylene oxide, or alternatively from about 10 to about 15 moles of ethylene oxide. In one or more embodiments, the non-ionic surfactant includes a polyethoxylated sorbitan ester having an average of about 20 moles of ethylene oxide. In one or more embodiments, the WCC includes from about 0.5 weight percent (wt. %) to about 40 wt. % of a polyethoxylated sorbitan ester, or a derivative thereof; or from about 0.5 wt. % to about 30 wt. % of a polyethoxylated sorbitan ester, or a derivative thereof; or from about 0.5 wt. % to about 20 wt. % of a polyethoxylated sorbitan ester, or a derivative thereof; or from about 1 wt. % to about 25 wt. % of a polyethoxylated sorbitan ester, or a derivative thereof; or from about 1 wt. % to about 15 wt. % of a polyethoxylated sorbitan ester, or a derivative thereof; or from about 1 wt. % to about 30 wt. % of a polyethoxylated sorbitan ester, or a derivative thereof; or from about 1 wt. % to about 35 wt. % of a polyethoxylated sorbitan ester, or a derivative thereof; or from about 20 wt. % to about 30 wt. % of a polyethoxylated sorbitan ester, or a derivative thereof. In one or more embodiments, the WCC according to the present disclosure may include a total weight percentage of a polyethoxylated sorbitan ester in a range of from about 2 wt. % to about 40 wt. %, or from about 2 wt. % to about 30 wt. %, or from about 3 wt. % to about 30 wt. %, or from about 4 wt. % to about 30 wt. %, or from about 5 wt. % to about 40 wt. %, or from about 5 wt. % to about 30 wt. %, or from about 10 wt. % to about 30 wt. %, or from about 15 wt. % to about 30 wt. %. In one or more embodiments, the WCC may include about 0.5, 0.8, 1.0, 1.2, 1.4, 1.6, 1.8, 2.0, 2.2, 2.4, 2.6, 2.8, 3.0, 3.2, 3.4, 3.6, 3.8, 4, 5, 6, 7, 8, 9, 10, 12, 14, 16, 18, 20, 22, 24, 26, 28, 30, 32, 34, 36, 38, or 40 weight percent of a polyethoxylated sorbitan ester, or a derivative thereof. In one or more embodiments, the WCC may include a polyethoxylated sorbitan ester, or a derivative thereof in an amount ranging between two endpoints selected from the following values: about 0.5, 0.8, 1.0, 1.2, 1.4, 1.6, 1.8, 2.0, 2.2, 2.4, 2.6, 2.8, 3.0, 3.2, 3.4, 3.6, 3.8, 4, 5, 6, 7, 8, 9, 10, 12, 14, 16, 18, 20, 22, 24, 26, 28, 30, 32, 34, 36, 38, or 40 weight percent.

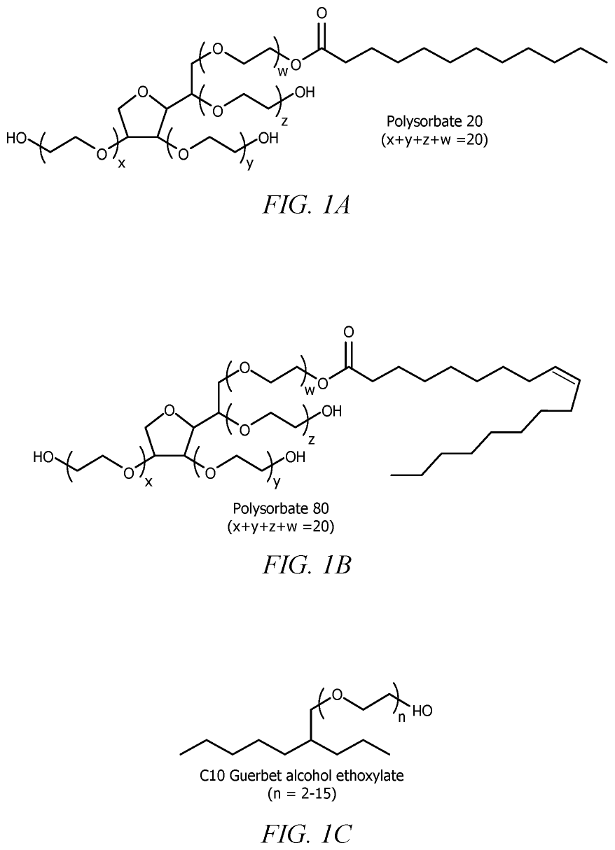

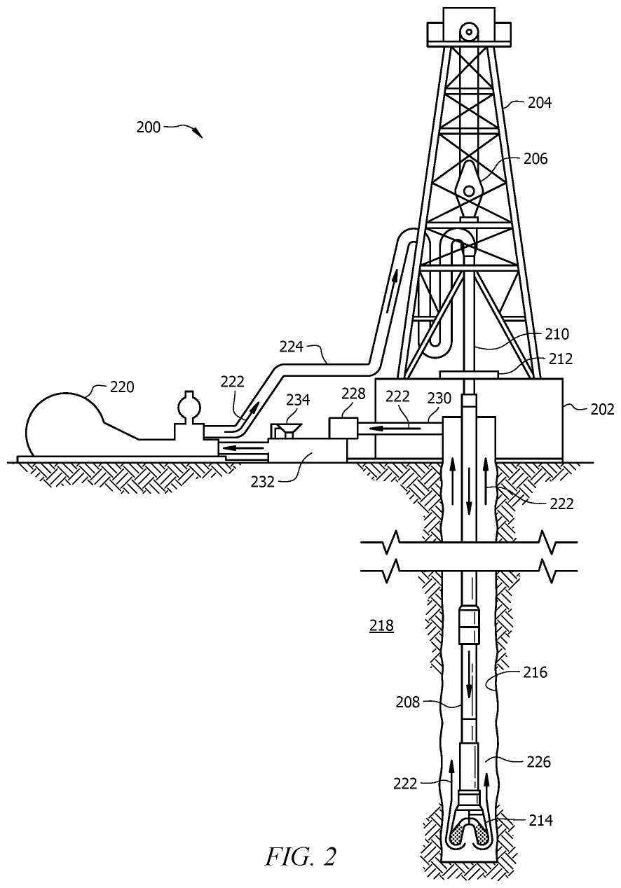

Structures of exemplary polyethoxylated sorbitan esters suitable for use in the present disclosure are depicted in FIGS. 1A and 1B. For example, commercially available non-ionic surfactants suitable for use in a WCC of the type disclosed herein include, without limitation, POLYSORBATE 20, POLYSORBATE 80, POLYSORBATE 21, POLYSORBATE 40, POLYSORBATE 41, POLYSORBATE 60, POLYSORBATE 61, and POLYSORBATE 65.

In one or more embodiments, the wellbore servicing fluid includes an alkoxylated branched alcohol as a surfactant. In one or more embodiments, the alkoxylated branched alcohol is a Guerbet alcohol ethoxylate. Guerbet alcohol ethoxylates are made from the ethoxylation of Guerbet alcohols, which are formed through a Guerbet reaction that converts an alcohol into a β-alkylated alcohol is shown in Scheme 1.

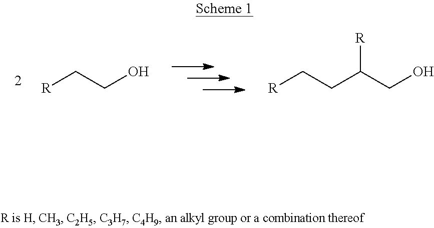

With reference to Scheme I, each R group depicted can be the same or the R groups may be different. In one or more embodiments, the Guerbet alcohol includes a C₆ to C₂₅ β-alkylated dimer alcohol alkoxylated with an ethoxylate moiety, alternatively a C₈ to C₂₀ β-alkylated dimer alcohol alkoxylated with an ethoxylate moiety or alternatively a C₈ to C₁₈ β-alkylated dimer alcohol alkoxylated with an ethoxylate moiety. Nonlimiting examples of Guerbet alcohols suitable for use in the present disclosure include 2-methyl-1-pentanol, 2-ethyl-1-butanol, 2-ethyl-1-hexanol, 2-propyl-1-heptanol, and 2-butyl-1-octanol.

In one or more embodiments, the Guerbet alcohol ethoxylate is present in the WCC in an amount of from about 1 wt. % to about 20 wt. %, alternatively from about 2 wt. % to about 20 wt. % or alternatively from about 3 wt. % to about 15 wt. % based on the total weight of the WCC. A structure of an exemplary Guerbet alcohol ethoxylate suitable for use in the present disclosure is depicted in FIG. 1C.

In one or more embodiments, the WCC includes a base fluid. A base fluid suitable for use in the WCC may include a solvent and a mutual solvent. As used herein, the term “base fluid” refers to the major component of the fluid (as opposed to components dissolved and/or suspended therein), and does not indicate any particular condition or property of that fluid such as its mass, amount, pH, etc.

In one or more embodiments, the base fluid includes at least one solvent. The solvent may be an oleaginous fluid, a polar solvent, an aqueous fluid or a combination thereof.

In one or more embodiments, the base fluid includes an oleaginous fluid. In one or more embodiments, the oleaginous fluid includes any petroleum oil, natural oil, synthetically-derived oil, mineral oil, base oil that is used to make oil-based drilling fluids, terpenes, such as d-limonene, hydrocarbons, or combinations thereof. The oleaginous fluids may be included in the WCC in an amount of from about 30 wt. % to about 90 wt. %, alternatively from about 40 wt. % to about 80 wt. % or alternatively from about 50 wt. % to about 70 wt. % based on the total weight of the WCC.

In one or more embodiments, the base fluid includes at least one polar solvent. Nonlimiting examples of polar solvents suitable for use in the WCC include butyl alcohol, pentanol, branched and linear hexanol, 2-ethylhexanol, 1-heptanol, 2-heptanol, octanol, C₆ to C₁₃ alkyl alcohols, diols, n-butyl lactate, isobutyl lactate, 2,2,4-trimethyl-1,3-pentanediol monoisobutyrate, butyl 2-hydroxybutyrate, and combinations thereof. The polar solvent may be included in the WCC in an amount of from about 0.5 wt. % to about 50 wt. %, alternatively from about 1 wt. % to about 40 wt. % or alternatively from about 2 wt. % to about 30 wt. % based on the total weight of the WCC. In an embodiment, the polar solvent includes 2-ethylhexanol.

In one or more embodiments, the base fluid includes an aqueous fluid. Aqueous fluids that may be suitable for use in the WCC may include water from any source. Such aqueous fluids may include fresh water, salt water (e.g., water containing one or more salts dissolved therein), brine (e.g., saturated salt water), seawater, and/or any combination thereof. The aqueous fluids may be from a source that does not contain compounds that adversely affect other components of a fluid. The aqueous fluid may be included in the WCC in an amount of from about 0 to about 30 wt. %, alternatively from about 1 wt. % to about 20 wt. % or alternatively from about 2 wt. % to about 10 wt. % based on the total weight of the WCC.

In one or more embodiments, the base fluid includes at least one mutual solvent. Herein a mutual solvent is defined as a material that is soluble in oil, water, and acid-based fluids. Given that the mutual solvent is miscible with more than one class of liquids, such materials may also be referred to as coupling agents because such materials can cause two ordinarily immiscible liquids to combine with each other. In one or more embodiments, the mutual solvent includes methanol, ethanol, n-propanol, isopropyl alcohol (IPA), butyl alcohol, methyl glycolate, ethyl glycolate, n-propyl glycolate, isopropyl glycolate, methyl lactate, ethyl lactate, n-propyl lactate, isopropyl lactate, ethylene glycol monobutyl ether, diethylene glycol monobutyl ether, triethylene glycol monobutyl ether, propylene glycol monobutyl ether (PGMBE), dipropylene glycol monobutyl ether, tripropylene monobutyl ether, diethylene glycol monoethyl ether, dipropylene glycol monomethyl ether, butylcarbitol, ethers or esters of glycols, glycerol, polyglycerol, polyols, derivatives thereof or, a combination thereof. In an embodiment, the mutual solvent includes ethylene glycol monobutyl ether (EGMBE). The mutual solvent may be included in the WCC in an amount of from about 5 wt. % to about 70 wt. %, alternatively from about 10 wt. % to about 60 wt. % or alternatively from about 15 wt. % to about 50 wt. % based on the total weight of the WCC.

A WCC of the present disclosure may be characterized by effectiveness across a broad pH range. For example, the WCC may have a pH ranging from about 4 to about 13, alternatively from about 8 to about 10, alternatively from about 10 to about 13, alternatively greater than about 4.5 to less than about 7, alternatively from about 5 to about 6.5 or, alternatively from about 5 to about 6.0. Any suitable methodology may be utilized to adjust the pH of the WCC to the disclosed ranges. For example, the pH may be adjusted through the use of any acid or base compatible with the other components of the WCC.

In one or more embodiments, the pH of the WCC ranges from greater than about 4.5 to about 7. In such embodiments, the WCC has a pH low enough to destabilize anionic emulsifiers that may be present in an OBM but is unable to remove carbonate from the formation. In one or more embodiments, the WCC has a pH of less than about 4.5. In such embodiments the WCC has a pH low enough to both destabilize anionic emulsifiers that may be present in an OBM and remove carbonate from the formation. In one or more embodiments, the pH of the WCC ranges from greater than about 8 to about 13. In such embodiments, the WCC having an alkaline pH is able to effectuate residual grease removal in the formation.

The WCC may be prepared using any suitable method and/or equipment (e.g., blenders, mixers, stirrers, etc.). The WCC may be prepared at a well site or at an offsite location.

The present disclosure in one or more embodiments provides methods for using the WCC in a variety of subterranean treatments or operations, including but not limited to, drilling operations, cementing operations, fracturing operations, gravel packing operations, workover operations, and the like. In one or more embodiments, the WCC is introduced to a subterranean formation or casing disposed within a subterranean formation subsequent to a drilling fluid having been circulated therein. In one or more embodiments, the WCC may be combined with other components or additives to formulate a suitable wellbore treatment fluid comprising a WCC of the type disclosed herein. For example, the WCC may be combined with an additional aqueous fluid, e.g., brine, to form a wellbore treatment fluid that is sometimes referred to as a wash pill. For example, a WCC of the type disclosed herein can be further combined (e.g., diluted) with an aqueous fluid to form a wash pill, and the wash pill can be placed downhole and contacted with an oil-containing surface downhole to remove all or a portion of the oil from the contacted surface.

In one or more embodiments, the WCC can be mixed with a brine to form a wash pill, and the wash pill can be placed downhole and contacted with an oil-containing surface downhole to remove all or a portion of the oil from the contacted surface. In one or more embodiments, the mixture of a WCC and brine (e.g., a wash pill) is placed downhole to remove residual mud from surfaces and/or convert surfaces from oil-wet to water wet. For example, the brine can include an aqueous base fluid with one or more water-soluble salts dissolved therein. In one or more embodiments, the one or more salts can include inorganic salts, formate salts, or any combination thereof. Inorganic salts may include monovalent salts, which may be further include alkali metal halides (e.g., sodium chloride), ammonium halides, and any combination thereof. Inorganic salts may include monovalent or divalent salts. Suitable brines can include, but are not limited to, sodium chloride brines, sodium bromide brines, potassium chloride brines, potassium bromide brines, magnesium chloride brines, calcium chloride brines, calcium bromide brines, zinc bromide brines, or a combination thereof.

In one or more embodiments, the brine has a density in the range of from about 9 to about 20 lbs/gal (pounds per gallon or “ppg”) (from about 1078 to about 2396 kg/m³), from about 9 to about 19.2 lbs/gal from about 1078 to about 2301 kg/m³), from about 9.5 to about 19.2 ppg (from about 1138 to about 2301 kg/m³), or from about 9 to about 18 ppg (from about 1078 to about 2157 kg/m³). In one or more embodiments, the brine has a density of greater than or equal to about 9, 9.5, 10.5, 11, 11.5, 12, 12.5, 13, 13.5, 14, 14.5, 15, 15.5, 16, 16.5, 17, 17.5, or 18 ppg (greater than or equal to about 1078, 1138, 1198, 1258, 1318, 1378, 1438, 1498, 1558, 1618, 1678, 1738, 1798, 1858, 1917, 1977, 2037, 2097, or 2157 kg/m³).

The wash pill may contain additives as desired to provide one or more user and/or application properties. For example, the wash pill may contain hydrophilic fibers, hydrophobic fibers or a combination thereof.

In one or more embodiments, a mixture of a WCC and brine (e.g., a wash pill) is prepared, wherein the brine is present in a volume percent of the mixture (e.g., wash pill) of from about 60% to about 95%, alternatively from about 70% to about 90%, or alternatively from about 80% to about 90% with the remainder of the mixture being the WCC.

In one or more embodiments, the mixture of a WCC and brine (e.g., a wash pill) may be introduced into a subterranean formation, a wellbore penetrating a subterranean formation, tubing (e.g., pipeline), and/or a container using any suitable method or equipment. Introduction of the mixture of a WCC and brine (e.g., a wash pill) may include delivery via any suitable methodology such as via a tube, umbilical, pump, gravity, and combinations thereof. The mixture of a WCC and brine (e.g., a wash pill) may, in various embodiments, be delivered downhole (e.g., into the wellbore) or into top-side flowlines/pipelines or surface treating equipment.

In one or more embodiments, the present disclosure provides methods and compositions for using the WCC, wellbore servicing fluids comprising the WCC (e.g., a wash pill), and/or additional additives to carry out a variety of subterranean treatments, including but not limited to, preflush treatments, afterflush treatments, wellbore clean-out treatments, drilling operations, and other operations where a WCC (or mixture of a WCC and brine, e.g., a wash pill) may be useful.

In one or more embodiments, the wellbore servicing fluid is used downhole at temperatures (e.g., a bottom hole circulating temperature, BHCT) ranging from about 20° F. to about 450° F., alternatively from about 20° F. to about 350° F., alternatively from about 20° F. to about 300° F., alternatively from about 20° F. to about 250° F., alternatively from about 20° F. to about 200° F., alternatively from about 25° F. to about 150° F. or, alternatively from about 40° F. to about 100° F.

The WCC or a wellbore treatment fluid comprising the WCC (e.g., a wash pill comprising a WCC of the type disclosed herein and additional aqueous fluid such as brine) may directly or indirectly affect one or more components or pieces of equipment associated with the preparation, delivery, recapture, recycling, reuse, and/or disposal of the WCC. For example, and with reference to FIG. 2, the WCC or a wellbore treatment fluid comprising the WCC (e.g., a wash pill comprising a WCC of the type disclosed herein and additional aqueous fluid such as brine) may directly or indirectly affect one or more components or pieces of equipment associated with an exemplary wellbore drilling assembly 200, according to one or more embodiments. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 200 may include a drilling platform 202 that supports a derrick 204 having a traveling block 206 for raising and lowering a drill string 208. The drill string 208 may include, but is not limited to, drill pipe and coiled tubing, as generally known to those skilled in the art. A kelly 210 supports the drill string 208 as it is lowered through a rotary table 212. A drill bit 214 is attached to the distal end of the drill string 208 and is driven either by a downhole motor and/or via rotation of the drill string 208 from the well surface. As the bit 214 rotates, it creates a borehole 216 that penetrates various subterranean formations 218.

A pump 220 (e.g., a mud pump) circulates drilling fluid 222 through a feed pipe 224 and to the kelly 210, which conveys the drilling fluid 222 downhole through the interior of the drill string 208 and through one or more orifices in the drill bit 214. The drilling fluid 222 is then circulated back to the surface via an annulus 226 defined between the drill string 208 and the walls of the borehole 216. At the surface, the recirculated or spent drilling fluid 222 exits the annulus 226 and may be conveyed to one or more fluid processing unit(s) 228 via an interconnecting flow line 230. After passing through the fluid processing unit(s) 228, a “cleaned” drilling fluid 222 is deposited into a nearby retention pit 232 (i.e., a mud pit). While illustrated as being arranged at the outlet of the wellbore 216 via the annulus 226, those skilled in the art will readily appreciate that the fluid processing unit(s) 228 may be arranged at any other location in the drilling assembly 200 to facilitate its proper function, without departing from the scope of the scope of the disclosure.

One or more wellbore servicing fluids may be added to the drilling fluid 222 via a mixing hopper 234 communicably coupled to or otherwise in fluid communication with the retention pit 232. The mixing hopper 234 may include, but is not limited to, mixers and related mixing equipment known to those skilled in the art. In other embodiments, however, wellbore servicing fluids may be added to the drilling fluid 222 at any other location in the drilling assembly 200. In at least one embodiment, for example, there could be more than one retention pit 232, such as multiple retention pits 232 in series. Moreover, the retention pit 232 may be representative of one or more fluid storage facilities and/or units where wellbore servicing fluids may be stored, reconditioned, and/or regulated until added to the drilling fluid 222.

As mentioned above, the WCC or a wellbore treatment fluid comprising the WCC (e.g., a wash pill comprising a WCC of the type disclosed herein and additional aqueous fluid such as brine) may directly or indirectly affect the components and equipment of the drilling assembly 200. For example, the WCC or a wellbore treatment fluid comprising the WCC (e.g., a wash pill comprising a WCC of the type disclosed herein and additional aqueous fluid such as brine) may directly or indirectly affect the fluid processing unit(s) 228 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, and any fluid reclamation equipment. The fluid processing unit(s) 128 may further include one or more sensors, gauges, pumps, compressors, and the like used store, monitor, regulate, and/or recondition the exemplary wellbore servicing fluids.

The WCC or a wellbore treatment fluid comprising the WCC (e.g., a wash pill comprising a WCC of the type disclosed herein and additional aqueous fluid such as brine) may directly or indirectly affect the pump 220, which representatively includes any conduits, pipelines, trucks, tubulars, and/or pipes used to fluidically convey the wellbore servicing fluids downhole, any pumps, compressors, or motors (e.g., topside or downhole) used to drive the wellbore servicing fluids into motion, any valves or related joints used to regulate the pressure or flow rate of the wellbore servicing fluids, and any sensors (i.e., pressure, temperature, flow rate, etc.), gauges, and/or combinations thereof, and the like. The WCC or a wellbore treatment fluid comprising the WCC (e.g., a wash pill comprising a WCC of the type disclosed herein and additional aqueous fluid such as brine) may also directly or indirectly affect the mixing hopper 234 and the retention pit 232 and their assorted variations.

The WCC or a wellbore treatment fluid comprising the WCC (e.g., a wash pill comprising a WCC of the type disclosed herein and additional aqueous fluid such as brine) may also directly or indirectly affect the various downhole equipment and tools that may come into contact with the WCC or a wellbore treatment fluid comprising the WCC (e.g., a wash pill comprising a WCC of the type disclosed herein and additional aqueous fluid such as brine) such as, but not limited to, the drill string 208, any floats, drill collars, mud motors, downhole motors and/or pumps associated with the drill string 208, and any MWD/LWD tools and related telemetry equipment, sensors or distributed sensors associated with the drill string 208. The WCC or a wellbore treatment fluid comprising the WCC (e.g., a wash pill comprising a WCC of the type disclosed herein and additional aqueous fluid such as brine) may also directly or indirectly affect any downhole heat exchangers, valves and corresponding actuation devices, tool seals, packers and other wellbore isolation devices or components, and the like associated with the wellbore 216. The WCC or a wellbore treatment fluid comprising the WCC (e.g., a wash pill comprising a WCC of the type disclosed herein and additional aqueous fluid such as brine) may also directly or indirectly affect the drill bit 214, which may include, but is not limited to, roller cone bits, PDC bits, natural diamond bits, any hole openers, reamers, coring bits, etc.

While not specifically illustrated herein, the WCC or a wellbore treatment fluid comprising the WCC (e.g., a wash pill comprising a WCC of the type disclosed herein and additional aqueous fluid such as brine) may also directly or indirectly affect any transport or delivery equipment used to convey the wellbore servicing fluids to the drilling assembly 200 such as, for example, any conduits, pipelines, trucks, tubulars, and/or pipes used to fluidically move the wellbore servicing fluids from one location to another, any pumps, compressors, or motors used to drive wellbore servicing fluids into motion, any valves or related joints used to regulate the pressure or flow rate of wellbore servicing fluids, and any sensors (i.e., pressure and temperature), gauges, and/or combinations thereof, and the like.

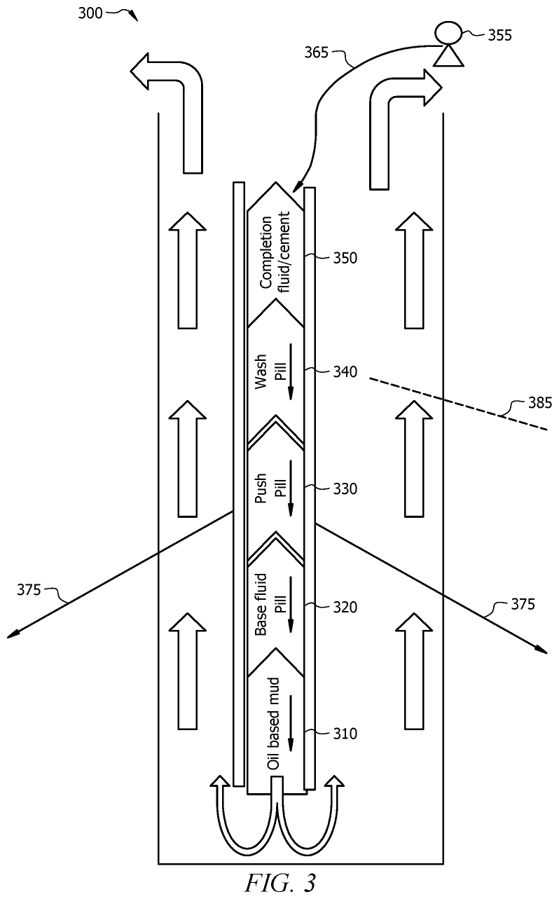

In one or more embodiments, a WCC or a wellbore treatment fluid comprising the WCC (e.g., a wash pill comprising a WCC of the type disclosed herein and additional aqueous fluid such as brine) of the present disclosure may function in a displacement train. With reference to FIG. 3, a displacement train 300 is depicted with a pump 355 placing downhole a series of wellbore servicing fluids through a conduit 365. In the displacement train depicted in FIG. 3, wellbore servicing fluids are placed into a conduit or tubular 375 (e.g., drill string and/or casing) and circulated back up through an annulus 385 where it may exit the wellbore with the fluid flow being indicated by the arrows. The displacement train shown in FIG. 3 depicts an exemplary sequence in which the fluids may be placed downhole and is not intended to limit the type and sequence of wellbore servicing fluids that may be placed downhole with a WCC of the type disclosed herein or a wellbore treatment fluid comprising the WCC (e.g., a wash pill comprising a WCC of the type disclosed herein and additional aqueous fluid such as brine).

In one or more embodiments, a method of the present disclosure includes placing a tubular (e.g., drillpipe and/or casing) into a wellbore to provide an annular space between the tubular and the wall of the wellbore. The method may further comprise servicing a wellbore (e.g., a wellbore having casing disposed therein that forms an annular space between the wellbore wall and an outer surface of the casing) via placement of a WCC of the type disclosed herein or a wellbore treatment fluid comprising the WCC (e.g., a wash pill comprising a WCC of the type disclosed herein and additional aqueous fluid such as brine) downhole and in contact with the interior of the tubular and/or the annular space. In such embodiments, a first fluid may be present in at least a portion of the interior of the tubular and/or the annular space, and the method disclosed herein includes placing a WCC into at least a portion of the annular space (e.g., via a flow path provided by the interior flow bore of the tubular).

In one or more embodiments, an exemplary displacement train, as depicted in FIG. 3, comprises a first wellbore servicing fluid, which is drilling fluid (e.g., oil based mud (OBM)) 310 of the type disclosed herein. The drilling fluid 310 herein refers to any liquid and gaseous fluid and mixtures of fluids and solids used in the operations of drilling a borehole into the earth. The drilling fluid 310 can be water based, non-water based (e.g., an OBM), and/or gaseous. In one or more embodiments, such as shown in FIG. 3, the drilling fluid 310 is an OBM. The OBM can form films on surfaces (e.g., the wellbore wall and/or the outer surface of the casing) of the annular space. In such embodiments, contact of the OBM 310 with one or surfaces creates an oil-wet surface. In an alternative aspect, the OBM excludes an organophilic clay. In one or more embodiments, the OBM is free of or substantially free of organophilic clay, for example the OBM contains equal to or less than 5, 4, 3, 2, 1, 0.5, 0.1, 0.01, or 0.001 weight percent organophilic clay.

With reference to FIG. 3, the next wellbore servicing fluid in the displacement train is a base fluid pill 320. The base fluid pill 320 may comprise the same base oil used in the OBM 310. The main function of the base fluid pill 320 is to provide separation between the OBM 310 and the aqueous cleaning pills to follow (e.g., push pill 330 and wash pill 340) that is circulated later in the displacement train. Without this separation, mixing of the OBM 310 and push pill 330 could hinder displacement of subsequent fluids placed in the wellbore and increase the interface volume. The use of a base fluid pill 320 advantageously provides (i) very low viscosity of the base fluid producing a high degree of turbulence, (ii) thinning of the OBM, reducing its yield point, which assists the fluid displacement, (iii) reduction in the density of the mud, which minimizes the negative effects of buoyancy in the casing annulus, and (iv) a solvent effect, which begins the cleaning process on the casing wall residues subsequent to the base fluid pill 320.

With reference to FIG. 3, the displacement train further comprises placing a push pill 330, also called a spacer fluid into the wellbore. The main function of the push pill 330 is to perform a thorough displacement of the mud. Mud displacement may be compromised by effects such as interface mixing, fluid channeling and buoyancy. Mixing of fluids at an interface is encouraged when the flowing fluid has a lower density and is moving in turbulent flow. The effectiveness of the push pill 330 may be maximized by viscosifying the fluid and increasing its density above that of the active fluid. The push pill 330 can be weighted up with the same agent used in the drilling fluid (i.e., OBM) 310, or alternatively the push pill 330 may be an aqueous based fluid and weighted accordingly (e.g., a brine based push pill). The degree to which the viscosity and the density are increased depends on the deviation of the well. The viscosity of the push pill 330 encourages laminar flow, which minimizes the tendency for channeling, minimizes mixing at the interface and slows down any fluid migration due to buoyancy effects. Increasing the density of the push pill 230 ensures that it is not buoyant in the mud and prevents channeling in deviated sections of the well. The displacement train may further comprise a wash pill 340, also called a cleaning fluid being placed in the wellbore. In one or more embodiments, the wash pill 340 comprises a WCC of the present disclosure or a wellbore treatment fluid comprising the WCC (e.g., a wash pill comprising a WCC of the type disclosed herein and additional aqueous fluid such as brine). The wash pill 340 performs the main cleaning action in the displacement train (e.g., via action of the surfactant component of the WCC as disclosed herein). The push pill 330 may displace the OBM 310 without leaving any discrete mud in the annulus 385 or may leave a residual layer of mud remaining on the casing and drillpipe surfaces 375. The wash pill 340 for use in the displacement train is characterized by both chemical and physical actions and includes a WCC of the type disclosed herein or a wellbore treatment fluid comprising the WCC (e.g., a wash pill comprising a WCC of the type disclosed herein and additional aqueous fluid such as brine). The wash pill 340 may be maintained in highly turbulent flow throughout the circulation in order to maximize the physical effect of introducing the wash pill 340 to the wellbore. In one or more embodiments, the WCC or a wellbore treatment fluid comprising the WCC (e.g., a wash pill comprising a WCC of the type disclosed herein and additional aqueous fluid such as brine) is used to displace an OBM having one or more characteristics selected from the group consisting of the presence of an organophilic clay, the absence of lignate or derivatives of lignite, the presence of a high density internal phase (e.g., phase comprising CaBr₂), and a combination thereof. With reference to FIG. 3, the displacement train may be finalized with placement of a completion fluid 350 (e.g., cement slurry) into the wellbore.

In one or more embodiments, the WCC or a wellbore treatment fluid comprising the WCC (e.g., a wash pill comprising a WCC of the type disclosed herein and additional aqueous fluid such as brine) functions to remove at least a portion of the OBM film from the surfaces of the annular space. In such embodiments, the WCC or a wellbore treatment fluid comprising the WCC (e.g., a wash pill comprising a WCC of the type disclosed herein and additional aqueous fluid such as brine) converts the surface of the annular space from oil-wet to water-wet, thereby facilitating subsequent wellbore servicing operations. For example, conversion of the surface from oil-wet to water-wet may facilitate cementing of the casing by increasing the cement bonding efficiency of the surfaces.

### Additional Disclosure

The following are non-limiting, specific embodiments in accordance with the present disclosure:

A first embodiment which is a wellbore cleaning composition comprising (i) a surfactant consisting essentially of a sorbitan ester or a derivative thereof and, (ii) a base fluid.

A second embodiment which is the wellbore servicing composition of the first embodiment wherein a second surfactant is present in an amount of less than about 5, 4.5, 4, 3.5, 3, 2.5, 2, 1.5, 1, 0.75, 0.5, 0.25, 0.1, 0.01, 0.001, 0.0001, or 0.00001 vol. % based on the total volume of the fluid.

A third embodiment which is the composition of any of the first through second embodiments wherein the sorbitan ester comprises sorbitan monolaurate, sorbitan monopalmitate, sorbitan monostearate, sorbitan monooleate, sorbitan sesquioleate, sorbitan trioleate, sorbitan isostearate, or polyethoxylated sorbitan esters.

A fourth embodiment which is the composition of any of the first through third embodiments wherein the sorbitan ester has a molecular weight of less than about 2600 Daltons.

A fifth embodiment which is the composition of any of the first through fourth embodiments wherein the sorbitan ester comprises polyethylene glycol sorbitan monolaurate, polyethylene glycol sorbitan monopalmitate, polyethylene glycol sorbitan monostearate, polyethylene glycol sorbitan tristearate, or polyethylene glycol sorbitan monooleate.

A sixth embodiment which is the composition of any of the first through fifth embodiments wherein the surfactant is present in an amount of from about 0.5 wt. % to about 40 wt. % based on the total weight of the fluid.

A seventh embodiment which is the composition of any of the first through sixth embodiments wherein the base fluid comprises at least one solvent and at least one mutual solvent.

An eighth embodiment which is the composition of the seventh embodiment wherein the solvent comprises an oleaginous fluid, a polar solvent, an aqueous fluid or a combination thereof.

A ninth embodiment which is the composition of the seventh embodiment wherein the oleaginous fluid comprises petroleum oil, natural oil, synthetically derived oil, mineral oil, base oil that is used to make oil-based drilling fluids, terpenes, such as d-limonene, hydrocarbons, or combinations thereof.

A tenth embodiment which is the composition of the seventh embodiment wherein the polar solvent comprises a linear alcohol, a branched alcohol, esters of alcohols, or a combination thereof.

An eleventh embodiment which is the composition of the seventh embodiment wherein the aqueous fluid comprises fresh water, salt water, brine, seawater, or a combination thereof.

A twelfth embodiment which is the composition of the seventh embodiment wherein the at least one mutual solvent comprises methanol, ethanol, n-propanol, isopropyl alcohol (IPA), butyl alcohol, methyl glycolate, ethyl glycolate, n-propyl glycolate, isopropyl glycolate, methyl lactate, ethyl lactate, n-propyl lactate, isopropyl lactate, ethylene glycol monobutyl ether, diethylene glycol monobutyl ether, triethylene glycol monobutyl ether, propylene glycol monobutyl ether (PGMBE), dipropylene glycol monobutyl ether, tripropylene monobutyl ether, diethylene glycol monoethyl ether, dipropylene glycol monomethyl ether, butylcarbitol, ethers or esters of glycols, glycerol, polyglycerol, and polyols, derivatives thereof or a combination thereof.

A thirteenth embodiment which is the composition of the seventh embodiment wherein the at least one mutual solvent comprises ethylene glycol monobutyl ether.

A fourteenth embodiment which is the wellbore treatment fluid comprising (1) a wellbore cleaning composition comprising (i) a surfactant consisting essentially of a sorbitan ester or a derivative thereof and (ii) a base fluid and (2) an additional bulk fluid.

A fifteenth embodiment which is the fluid of the fourteenth embodiment wherein the bulk fluid comprises a brine.

A sixteenth embodiment which the fluid of any of the fourteenth through fifteenth embodiments wherein the brine comprises sodium chloride brines, sodium bromide brines, potassium chloride brines, potassium bromide brines, magnesium chloride brines, calcium chloride brines, calcium bromide brines, zinc bromide, or a combination thereof.

A seventeenth embodiment which is the fluid of any of the fourteenth though sixteenth embodiments wherein the brine has a density in the range of from about 9 lbs/gal to about 20 lbs/gal.

An eighteenth embodiment which is the fluid of any of the fourteenth through seventeenth embodiments having a pH of from about 4 to about 13.

A nineteenth embodiment which is a method of serving a wellbore disposed within a subterranean formation comprising circulating an oil-based drilling mud through an interior of a drill string and an annulus; and placing within the wellbore a wash pill comprising (1) a wellbore cleaning composition comprising (i) a surfactant consisting essentially of a sorbitan ester or a derivative thereof and (ii) a base fluid and (2) a brine under conditions suitable for the conversion of one or more surfaces of the wellbore from oil-wet to water-wet.

A twentieth embodiment which is the method of the nineteenth embodiment wherein the sorbitan ester comprises sorbitan monolaurate, sorbitan monopalmitate, sorbitan monostearate, sorbitan monooleate, sorbitan sesquioleate, sorbitan trioleate, sorbitan isostearate, or polyethoxylated sorbitan esters.

A twenty-first embodiment which is the method of any of the nineteenth through twentieth embodiments wherein the sorbitan ester comprises polyethylene glycol sorbitan monolaurate, polyethylene glycol sorbitan monopalmitate, polyethylene glycol sorbitan monostearate, polyethylene glycol sorbitan tristearate, or polyethylene glycol sorbitan monooleate.

A twenty-second embodiment which is the method of any of the nineteenth through twenty-first embodiments wherein the base fluid comprises at least one solvent and at least one mutual solvent.

A twenty-third embodiment which is the method of the twenty-second embodiment wherein the solvent comprises an oleaginous fluid, a polar solvent, an aqueous fluid or a combination thereof.

A twenty-fourth embodiment which is a method of serving a wellbore disposed within a subterranean formation comprising circulating an oil-based drilling mud through an interior of a drill string and an annulus; and placing within the wellbore a wash pill comprising (1) a wellbore cleaning composition comprising (i) a surfactant consisting essentially of a polyethoxylated sorbitan ester or a derivative thereof and (ii) a base fluid and (2) a brine under conditions suitable for the conversion of one or more surfaces of the wellbore from oil-wet to water-wet.

A twenty-fifth embodiment which is the method of any of the nineteenth through twenty-fourth embodiments wherein the oil-based drilling fluid is free of or substantially free of organo-clay, for example the OBM contains equal to or less than 5, 4, 3, 2, 1, 0.5, 0.1, 0.01, or 0.001 weight percent organo-clay.

### EXAMPLE

The embodiments having been generally described, the following example is given as particular embodiments of the disclosure and to demonstrate the practice and advantages thereof. It is understood that the example is given by way of illustration and is not intended to limit the specification or the claims in any manner.

### Example 1

Three WCCs of the type disclosed herein was prepared and designated Samples #1, #2 and #3. The sample components are shown in Table 1.

TABLE 1

| Component in wt. %¹ | Sample #1 | Sample #2 | Sample #3 |
|---|---|---|---|
| Hydrotreated Light Distillate | 63 | 63 | 52 |
| Ethylene glycol monobutyl | 30 | 30 | 35 |
| ether (EGBME) | | | |
| 2-Ethylhexanol | 2 | 5 | 5 |
| POLYSORBATE 20 | 5 | — | — |
| POLYSORBATE 80 | — | 5 | — |
| C10- Guerbet alcohol ethoxylate | — | — | 5 |
| Water | — | — | 3 |

¹wt. % herein refers to weight percentage based on the total weight of sample, cleaner + 85% of brine). The three brines used were 11.6 lb/gal CaCl₂, 12.5 lb/gal NaBr, and 14.2 lb/gal CaBr₂.

The base fluid for all samples contained two solvents and a mutual solvent, EGBME. The solvents for Samples #1 and #2 were a hydrotreated light distillate and 2-ethylhexanol while Sample #3 additionally contained water. Hydrotreated light distillate is a complex combination of hydrocarbons obtained by treating a petroleum fraction with hydrogen in the presence of a catalyst and is commercially available from numerous vendors. Sample #1 contained POLYSORBATE 20, which is a nonionic surfactant based on sorbitan ethoxylate esters with a fatty acid group, Sample #2 contained POLYSORBATE 80, which is a nonionic surfactant based on sorbitan ethoxylate esters with a fatty acid group that differs from that of POLYSORBATE 20 and Sample #3 contained a C₁₀ Guerbet alcohol ethoxylate as the surfactant. The extent of mud removal obtained for each of the three samples was compared to the extent of mud removal obtained when using a commercially available cleaner.

The mixture, termed the wash pill, that was tested for efficiency of mud removal contained (i) Sample #1, Sample #2, or Sample #3 and (ii) a brine. Specifically, each sample was mixed with one of three different brines at a concentration of 15 volume percent (vol %) (15% of

The three brines used were 11.6 lb/gal CaCl₂, 12.5 lb/gal NaBr, and 14.2 lb/gal CaBr₂.

Mud removal tests were conducted using a specialized closed-end Fann® 35 rheometer sleeve which was weighed to provide an initial mass, M1, before immersion in a beaker of oil-based drilling mud at a specified temperature and 100 rpm rotation for 15 minutes. The oil-based drilling mud used was commercially available from Halliburton Energy Services. The mud-coated sleeve was then weighed, to give mass M2, before being immersed in the wash pill and rotated at 100 rpm for 5 minutes. The sleeve was then rinsed with water at 100 rpm for additional 5 minutes. Following the water wash, the sleeve was dried in an oven at 212° F. (100° C.) for 5 minutes and cooled down to room temperature. The final mass of the cleaned sleeve, designated M3, the initial mass of the clean sleeve, M1, and the mass of the coated sleeve, M2 were then used to calculate percent mud removal with the following equation:

$$\% Mud Removal = \frac{M 2 - M 3}{M 2 - M 1} * 100$$

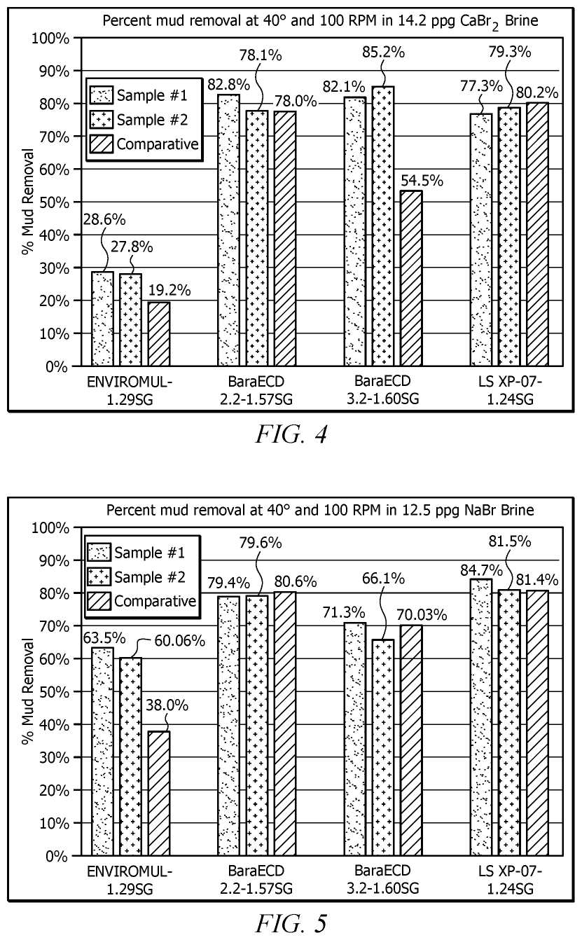

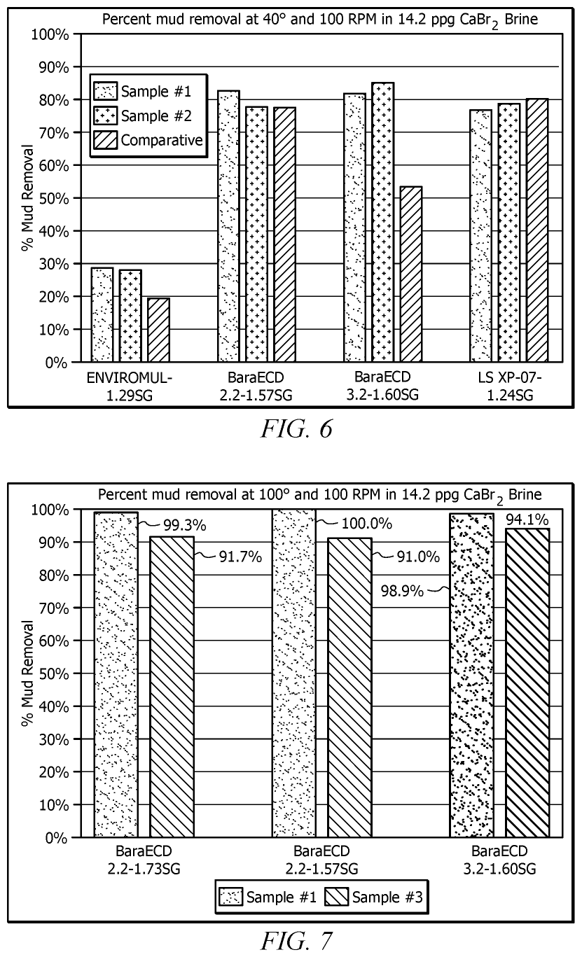

FIGS. 4-6 are plots of the percent mud removal based for samples prepared using one of the three cleaners, one of the four different field oil-based drilling fluids, and one of the three different brines: 11.6 ppg CaCl₂, 12.5 ppg NaBr, and 14.1 ppg CaBr₂brine. The four oil-based drilling fluids used were ENVIROMUL with a specific gravity (SG) of 1.29, BARAECD 2.2 with an SG of 1.57, BARAECD 3.2 with an SG of 1.60, and LS XP-07 with an SG of 1.24. ENVIRONMUL is a synthetic oil-based mud and LS XP-07 is a linear alkane-based invert emulsion fluid, both of which are commercially available from Baroid. BARAECD is a line of high-performance non-aqueous drilling fluid systems commercially available from Halliburton Energy Services. When tested in 11.6 ppg CaCl₂ and 12.5 ppg NaBr brine, the two cleaners having either POLYSORBATE 80 or POLYSORBATE 20 gave a higher percent mud removal in ENVIROMUL and comparable percent mud removal in the three other oil-based drilling fluids tested.

### Example 2

The extent of mud removal was evaluated using the procedure and samples described in Example 1 with a 14.2 ppg CaBr₂ brine. FIG. 7 shows the percent mud removal of the indicated samples at 100° F. (37.8° C.). The results show that, when tested in 14.2 ppg CaBr₂brine, Sample #1 containing the sole surfactant POLYSORBATE 20 provided better mud removal than Sample #3, which contained a C10 Guerbet alcohol ethoxylate as the sole surfactant.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. When a feature is described as “optional,” both embodiments with this feature and embodiments without this feature are disclosed. Similarly, the present disclosure contemplates embodiments where this feature is required and embodiments where this feature is specifically excluded. Both alternatives are intended to be within the scope of the claim. Use of broader terms such as includes, includes, having, etc. should be understood to provide support for narrower terms such as consisting of, consisting essentially of, included substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure.

What is claimed is:

1. A wellbore cleaning composition comprising (i) a surfactant consisting essentially of a sorbitan ester or a derivative thereof and, (ii) a base fluid.

2. The composition of claim 1, wherein a second surfactant is present in an amount of less than about 5 vol. % based on the total volume of the fluid.

3. The composition of claim 1, wherein the sorbitan ester comprises sorbitan monolaurate, sorbitan monopalmitate, sorbitan monostearate, sorbitan monooleate, sorbitan sesquioleate, sorbitan trioleate, sorbitan isostearate, or polyethoxylated sorbitan esters.

4. The composition of claim 1, wherein the sorbitan ester has a molecular weight of less than about 2600 Daltons.

5. The composition of claim 1, wherein the sorbitan ester comprises polyethylene glycol sorbitan monolaurate, polyethylene glycol sorbitan monopalmitate, polyethylene glycol sorbitan monostearate, polyethylene glycol sorbitan tristearate, or polyethylene glycol sorbitan monooleate.

6. The composition of claim 1, wherein the surfactant is present in an amount in a range of from equal to or greater than about 0.5 wt. % to equal to or less than about 40 wt. % based on the total weight of the fluid.

7. The composition of claim 1, wherein the base fluid comprises at least one solvent and at least one mutual solvent.

8. The composition of claim 7, wherein the solvent comprises an oleaginous fluid, a polar solvent, an aqueous fluid or a combination thereof.

9. The composition of claim 7, wherein the oleaginous fluid comprises petroleum oil, natural oil, synthetically derived oil, mineral oil, base oil that is used to make oil-based drilling fluids, terpenes, such as d-limonene, hydrocarbons, or combinations thereof.

10. The composition of claim 7, wherein the polar solvent comprises a linear alcohol, a branched alcohol, esters of alcohols, or a combination thereof.

11. The composition of claim 7, wherein the aqueous fluid comprises fresh water, salt water, brine, seawater, or a combination thereof.

12. The composition of claim 7, wherein the at least one mutual solvent comprises methanol, ethanol, n-propanol, isopropyl alcohol (IPA), butyl alcohol, methyl glycolate, ethyl glycolate, n-propyl glycolate, isopropyl glycolate, methyl lactate, ethyl lactate, n-propyl lactate, isopropyl lactate, ethylene glycol monobutyl ether, diethylene glycol monobutyl ether, triethylene glycol monobutyl ether, propylene glycol monobutyl ether (PGMBE), dipropylene glycol monobutyl ether, tripropylene monobutyl ether, diethylene glycol monoethyl ether, dipropylene glycol monomethyl ether, butylcarbitol, ethers or esters of glycols, glycerol, polyglycerol, and polyols, derivatives thereof or a combination thereof.

13. The composition of claim 7, wherein the at least one mutual solvent comprises ethylene glycol monobutyl ether.

14. A wellbore treatment fluid comprising (1) (i) a surfactant consisting essentially of a sorbitan ester or a derivative thereof and, (ii) a base fluid and (2) an additional bulk fluid.

15. The treatment fluid of claim 14, wherein the bulk fluid comprises a brine.

16. A method of serving a wellbore disposed within a subterranean formation comprising; circulating an oil-based drilling mud through an interior of a drill string and an annulus; and placing within the wellbore a wash pill comprising (1) the wellbore cleaning composition of claim 1 and (ii) a base fluid and (2) a brine under conditions suitable for the conversion of one or more surfaces of the wellbore from oil-wet to water-wet.

17. A wellbore cleaning fluid comprising (i) an alkoxylated branched alcohol and (ii) a base fluid.

18. The fluid of claim 17, wherein the alkoxylated branched alcohol comprises an alkoxylated Guerbet alcohol.

19. The fluid of claim 18, wherein the alkoxylated Guerbet alcohol comprises an ethoxylate.

20. The fluid of claim 17, wherein the alkoxylated branched alcohol comprises a C₆ to C₂₅ β-alkylated dimer alcohol alkoxylated with an ethoxylate moiety, a C₈ to C₂₀ β-alkylated dimer alcohol alkoxylated with an ethoxylate moiety, a C₁₀ to C₂₀ β-alkylated dimer alcohol alkoxylated with an ethoxylate moiety or a combination thereof.

21. The fluid of claim 17, wherein the base fluid comprises at least one solvent, at least one mutual solvent, or both.

22. A method of serving a wellbore disposed within a subterranean formation comprising; circulating an oil-based drilling mud through an interior of a drill string and an annulus; and placing within the wellbore the wellbore cleaning fluid of claim 17 under conditions suitable for the conversion of the one or more surfaces from oil wet to water wet.
